(19) United States
(12) Patent Application Publication
(10) Pub. No.: US 2025/0296369 A1
(43) Pub. Date: Sep. 25, 2025

(54) PRINTER, METHOD, AND STORAGE MEDIUM

(71) Applicant: Toshiba Tec Kabushiki Kaisha, Tokyo (JP)

(72) Inventors: Yuki TAKAGI, Singapore (SG); Kenji EOKA, Sunto Shizuoka (JP)

(21) Appl. No.: 19/026,126

(22) Filed: Jan. 16, 2025

(30) Foreign Application Priority Data
Mar. 22, 2024 (JP) 2024-045860

(51) Int. Cl. B41J 13/10; B41J 11/00; B41J 11/70; B41J 13/00; B41J 13/03; B41J 29/13

(52) U.S. Cl. CPC B41J 13/106; B41J 11/0095; B41J 11/70; B41J 13/0027; B41J 13/0036; B41J 13/03; B41J 29/13

(57) ABSTRACT

A printer includes a roller that conveys a sheet in a conveyance direction, a print head configured to perform printing on the sheet, a cutter that cuts the sheet that is conveyed by the roller and on which the printing is performed by the print head, a support member that is disposed at a sheet discharge port from which the sheet cut by the cutter is discharged and supports the sheet discharged from the sheet discharge port from the back side of the sheet, and a biasing member that is disposed between the cutter and the support member in the conveyance direction and biases the sheet from the front side of the sheet. The support member and the biasing member partially overlap each other when viewed from the conveyance direction so that the sheet cut by the cutter is held between the support member and the biasing member.

### CROSS-REFERENCE TO RELATED APPLICATION

This application is based upon and claims the benefit of priority from Japanese Patent Application No. 2024-045860, filed Mar. 22, 2024, the entire contents of which are incorporated herein by reference.

### FIELD

Embodiments described herein relate generally to a printer, a method, and a storage medium.

### BACKGROUND

Conventionally, there are two types of auto-cut methods for a printer: full cut and partial cut. In the partial cut, a cut portion of a sheet roll is still partially attached to the rest of the sheet roll and therefore does not fall off after being cut. However, in the case of the full cut, a cut portion of a sheet roll falls off from a sheet discharge port.

### SUMMARY OF THE INVENTION

An aspect of the present disclosure provides a printer, a method, and a storage medium that can prevent a cut sheet from falling off from a sheet discharge port.

According to an aspect of the present disclosure, a printer includes a roller that conveys a sheet in a conveyance direction, a print head that performs printing on the sheet, a cutter that cuts the sheet that is conveyed by the roller and on which the printing is performed by the print head, a support member that is disposed at a sheet discharge port from which the sheet cut by the cutter is discharged and supports the sheet discharged from the sheet discharge port from the back side of the sheet, and a biasing member that is disposed between the cutter and the support member in the conveyance direction and biases the sheet from the front side of the sheet. The support member and the biasing member partially overlap each other when viewed from the conveyance direction so that the sheet cut by the cutter is held between the support member and the biasing member.

### BRIEF DESCRIPTION OF THE DRAWINGS

FIG. 1 is a diagram illustrating a schematic configuration of a printer according to an embodiment.

FIG. 2 is a diagram illustrating an example of a hardware configuration of the printer.

FIG. 3 is a diagram illustrating an example of an external appearance of the printer in a case where a sheet discharge port faces a horizontal direction.

FIG. 4 is a diagram illustrating a state in which a cover of the printer illustrated in FIG. 3 is opened.

FIG. 5 is a diagram illustrating an example of an external appearance of the printer in a case where a sheet discharge port faces a vertical direction.

FIG. 6 is a diagram illustrating a state in which a cover of the printer illustrated in FIG. 5 is opened.

FIG. 7 is a cross-sectional view of the printer taken along line A-A in FIG. 3.

FIG. 8 is a cross-sectional view illustrating a state in which a cover in FIG. 7 is opened.

FIG. 9 is an enlarged view of a part of the cross-sectional view shown in FIG. 7.

FIG. 10 is a diagram illustrating a state in which a biasing member is rotated around a rotation shaft due to a jam in a direction opposite to a biasing direction.

FIG. 11 is a diagram illustrating a sheet pulled state.

FIG. 12 is a flowchart illustrating an example of a process performed by the printer.

### DETAILED DESCRIPTION

Hereinafter, embodiments of the present disclosure will be described in detail with reference to the drawings. The present disclosure is not limited to the embodiments described below.

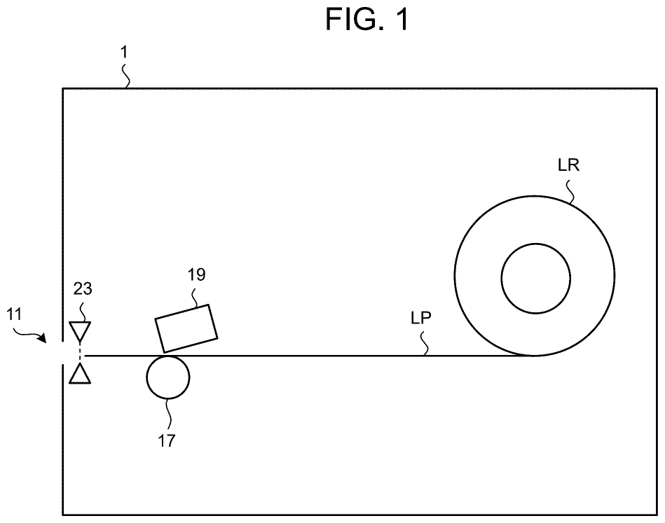

FIG. 1 is a diagram illustrating a schematic configuration of a printer 1 according to an embodiment. Below, an outline of the printer 1 will be described with reference to FIG. 1. The printer 1 is, for example, a thermal printer. The printer 1 is used, for example, as a receipt printer for printing a receipt.

The printer 1 houses a sheet roll LR formed by winding a sheet LP, which is an example of a print sheet, into a roll. The printer 1 performs printing on the sheet LP while pulling out the sheet LP from the sheet roll LR. The printer 1 includes a sheet discharge port 11, a platen roller 17, a print head 19, and a cutter 23. The sheet discharge port 11 discharges the sheet LP cut by the cutter 23.

The print head 19 is an example of a printing unit. The print head 19 of the present embodiment is a thermal head including an array of heating elements. The print head 19 performs printing on the sheet LP sandwiched between the platen roller 17 and the print head 19 by causing heating elements corresponding to a printing pattern to generate heat. The print head 19 is biased toward the platen roller 17 by a biasing mechanism (not shown). With the biasing mechanism, the print head 19 is brought into contact with the platen roller 17.

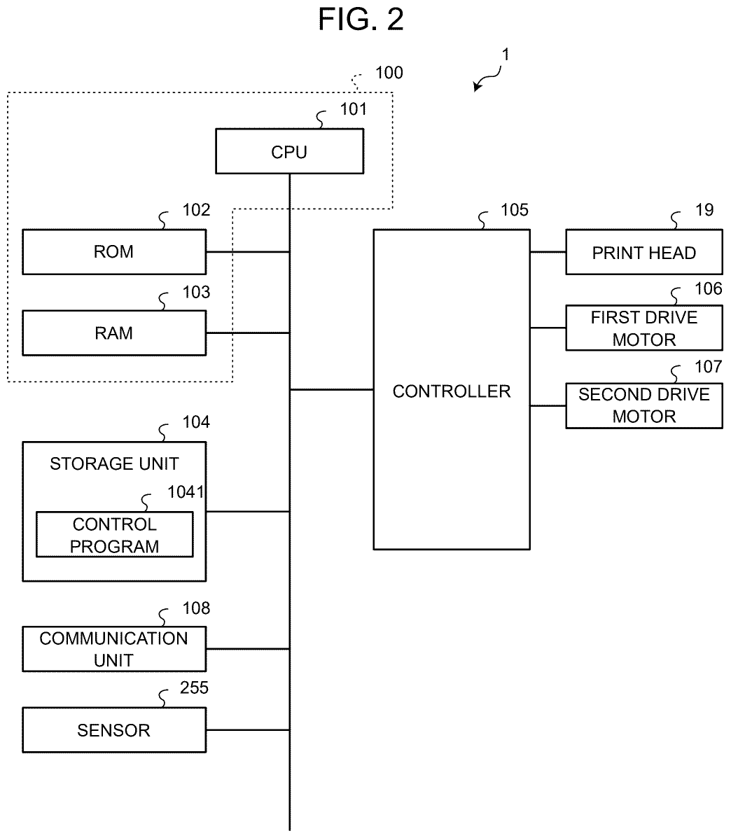

The cutter 23 cuts the sheet LP conveyed by a conveyance mechanism, such as the platen roller 17. Specifically, the cutter 23 includes a movable blade and a fixed blade. The movable blade is movable in the thickness direction of the sheet LP. The movable blade is moved up and down by a moving mechanism under the control of a control unit 100 (see FIG. 2) included in the printer 1. The fixed blade is provided at a position facing the movable blade. When printing on the sheet LP is completed, the movable blade moves from the back side of the sheet LP toward the front side of the sheet LP so that the sheet LP is cut by being sandwiched between the movable blade and the fixed blade. The front side of the sheet corresponds to, for example, a printing surface of the sheet LP. The back side of the sheet LP corresponds to a non-printing surface of the sheet LP that is opposite to the printing surface.

Note that the cutter 23 may be used not only to fully cut off the sheet LP (which is referred to as a “full cut”) but also to partially cut the sheet LP (which is referred to as a “partial cut”). Whether the cutter 23 is used for the full cut or the partial cut is set in advance according to an instruction input by the user via an operation unit (not shown).

Next, a hardware configuration of the printer 1 will be described with reference to FIG. 2. FIG. 2 is a diagram illustrating an example of a hardware configuration of the printer 1.

As illustrated in FIG. 2, the printer 1 includes a CPU (Central Processing Unit) 101, a ROM (Read-Only Memory) 102, and a RAM (Random Access Memory) 103.

The CPU 101 is an example of a processor and controls the printer 1. The ROM 102 stores various programs. Various types of data and programs are loaded into the RAM 103. The CPU 101, the ROM 102, and the RAM 103 are connected to each other via a bus and the like. The CPU 101, the ROM 102, and the RAM 103 constitute a control unit 100. That is, in the control unit 100, the CPU 101 operates in accordance with a control program 1041, which is stored in the ROM 102 or a storage unit 104 and loaded into the RAM 103, to perform control processes related to operations of the printer 1.

The storage unit 104 is implemented by a non-volatile memory, such as an HDD (Hard Disc Drive) or a flash memory, that retains data even when the power is turned off. The storage unit 104 is an example of a non-transitory computer-readable storage medium. The storage unit 104 stores the control program 1041 for controlling the operations of the printer 1. The control program 1041 is an example of a program for causing the processor of the printer 1 to perform a process. Also, the storage unit 104 stores various types of setting information related to the operations of the printer 1.

The control unit 100 is connected via a bus or the like to a controller 105 that controls input and output of data. The print head 19, a first drive motor 106, a second drive motor 107, and the like are connected to the controller 105.

The first drive motor 106 is a drive source of the platen roller 17. The first drive motor 106 is an example of a first drive unit. The first drive motor 106 is implemented by, for example, a stepping motor. Here, the first drive motor 106 functions as an example of a conveyance unit that conveys the sheet LP in a feeding direction (or a forward direction) in conjunction with the platen roller 17.

The second drive motor 107 is a drive source of the cutter 23. The second drive motor 107 is provided in a moving mechanism that moves the movable blade of the cutter 23. The second drive motor 107 is an example of a second drive unit. The second drive motor 107 is implemented by, for example, a DC motor.

The controller 105 receives an instruction from the control unit 100 and controls the operation of each component of the printer 1. For example, the controller 105 controls the operation of the first drive motor 106 to feed the sheet LP at a predetermined conveyance rate.

The control unit 100 is connected to a communication unit 108 via a bus or the like. The communication unit 108 communicates with an external device, such as an information processing device, via a communication line (not shown). For example, the communication unit 108 acquires print data to be printed on the sheet LP, or acquires a print instruction, from an external device. The communication line may be a wired communication line or a wireless communication line.

The hardware configuration of the printer 1 is not limited to that illustrated in FIG. 2. For example, the printer 1 may include an operation unit for receiving an operation from the user, a display unit for displaying various types of information, and the like.

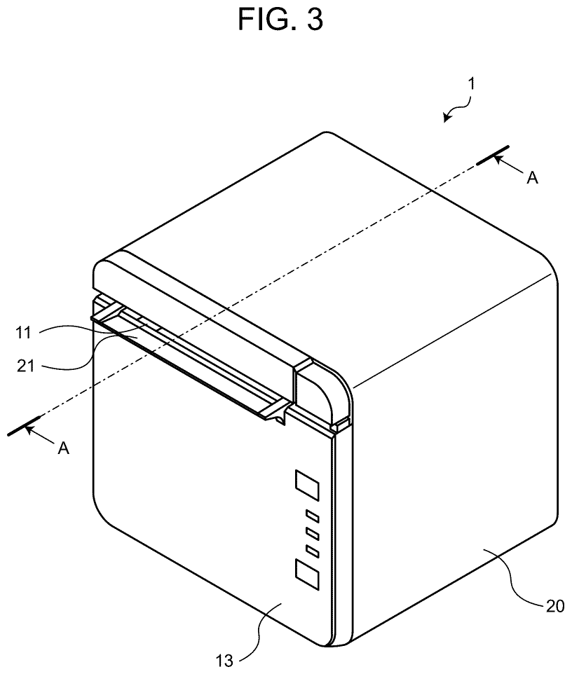

Next, the external appearance, configuration, and the like of the printer 1 will be described with reference to FIG. 3. FIG. 3 is a diagram illustrating an example of an external appearance of the printer 1 when the sheet discharge port 11, through which the sheet LP cut by the cutter 23 is discharged, faces the horizontal direction. In FIG. 3, a printed sheet LP is discharged horizontally from the printer 1.

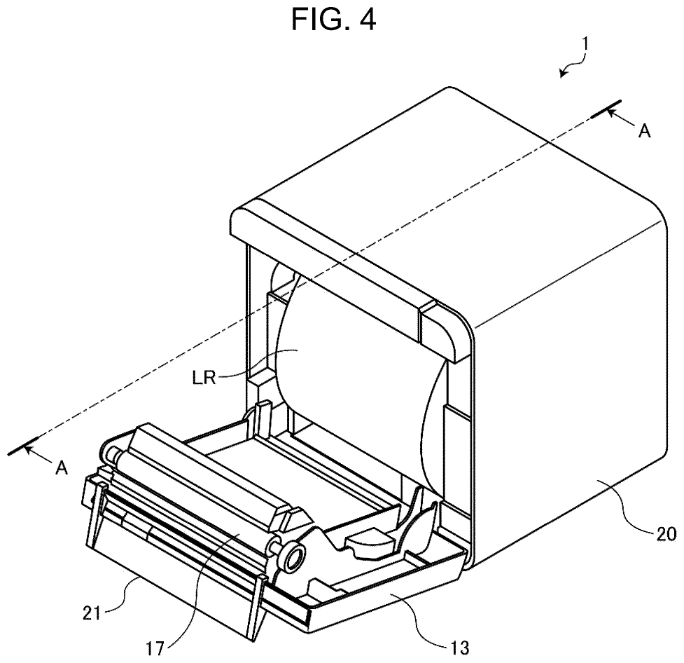

FIG. 4 is a diagram illustrating a state in which a cover 13 of the printer 1 illustrated in FIG. 3 is opened. The cover 13 opens and closes an opening of a body 20 of the printer 1. As illustrated in FIG. 4, the sheet roll LR, which is a roll of the sheet LP, is housed in the printer 1. The platen roller 17 is mounted on the cover 13. In this state, the print head 19 is located in the body 20. The positional relationship between the platen roller 17 and the print head 19 is not limited to that illustrated in FIG. 4. For example, the print head 19 may be mounted on the cover 13, and the platen roller 17 may be disposed in the body 20 of the printer 1. When the printer 1 is installed as shown in FIGS. 3 and 4, a front side may be referred to as an upper side, and a back side may be referred to as a lower side.

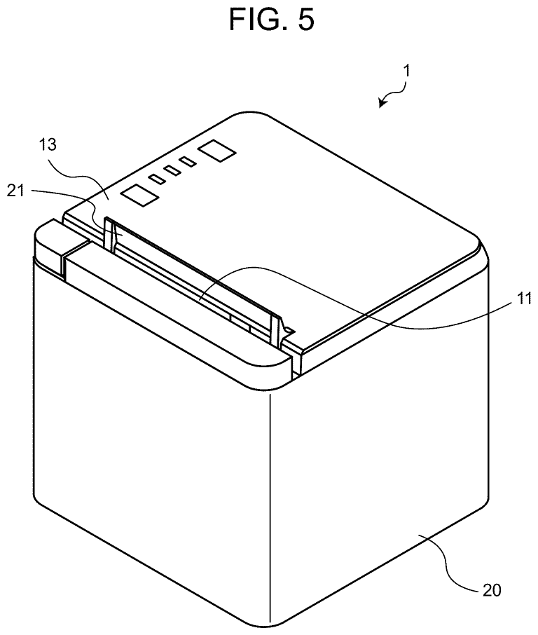

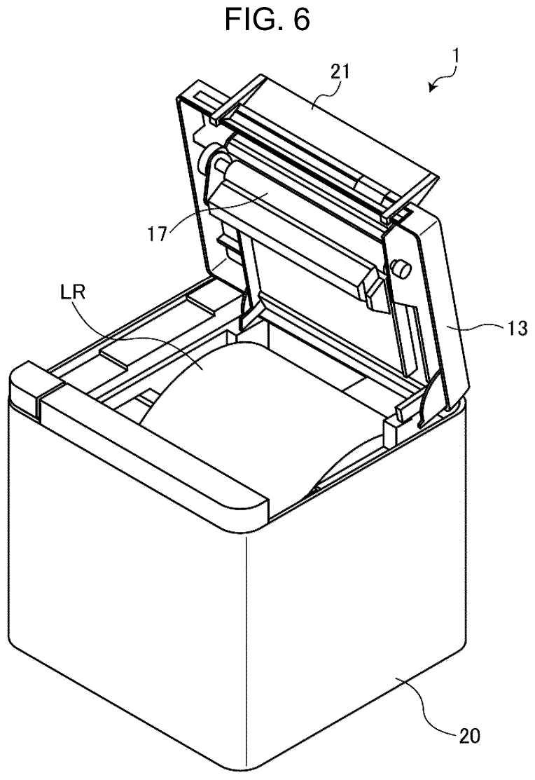

The printer 1 is not necessarily installed as illustrated in FIGS. 3 and 4. For example, the printer 1 may be installed such that the sheet discharge port 11 faces upward, i.e., the vertical direction. FIG. 5 is a diagram illustrating an example of an external appearance of the printer 1 when the sheet discharge port 11 faces the vertical direction. In FIG. 5, a printed sheet LP is discharged from the printer 1 vertically upward. FIG. 6 is a diagram illustrating a state in which the cover 13 of the printer 1 illustrated in FIG. 5 is opened. In the descriptions below, for explanation purposes, it is assumed that the printer 1 is installed such that the sheet discharge port 11 faces the horizontal direction.

As illustrated in FIGS. 3 to 6, a support member 21 is provided at the sheet discharge port 11 of the cover 13 of the printer 1. The support member 21 supports the back side of the sheet LP discharged from the sheet discharge port 11. The support member 21 is detachably attached to the sheet discharge port 11 or formed as an integral part of the sheet discharge port 11. That is, the support member 21 is either formed as a component that is detachably attached to the cover 13 or formed as an integral part of the cover 13. The support member 21 that supports the sheet LP from the back side may also be referred to as a table.

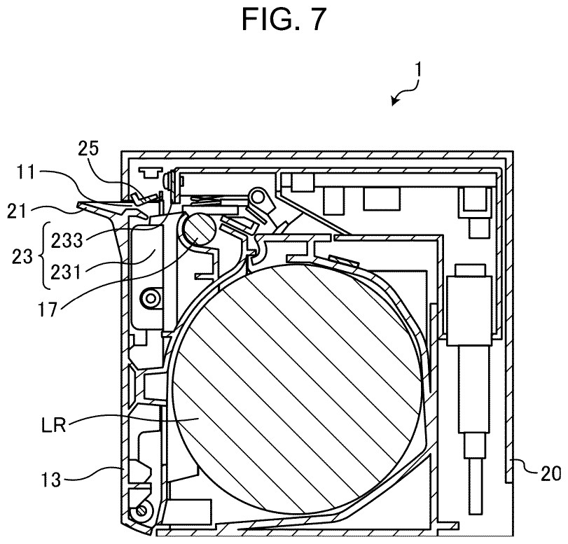

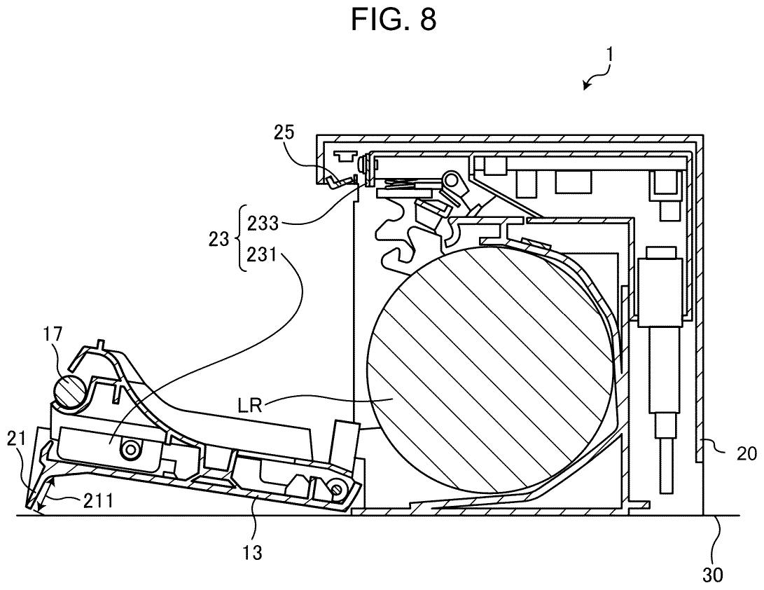

FIG. 7 is a cross-sectional view of the printer 1 taken along line A-A in FIG. 3. FIG. 8 is a cross-sectional view of the printer 1 taken along line A-A in FIG. 4. FIG. 8 shows a state in which the cover 13 of the printer 1 in FIG. 7 is opened. As shown in FIG. 8, the length of a protruding part 211 (or a protrusion) of the support member 21 and the inclination of the protruding part 211 with respect to the discharge direction or the conveyance direction of the sheet LP are set such that the sheet roll LR can be inserted through the opening into the body 20 when, for example, the cover 13 is opened up to a horizontal surface 30 on which the printer 1 is installed, that is, when the cover 13 is opened until the protruding part 211 of the support member 21 contacts the horizontal surface 30. That is, the length of the protruding part 211 and the inclination of the protruding part 211 are set in advance such that the sheet roll LR can be replaced through the opening of the printer 1.

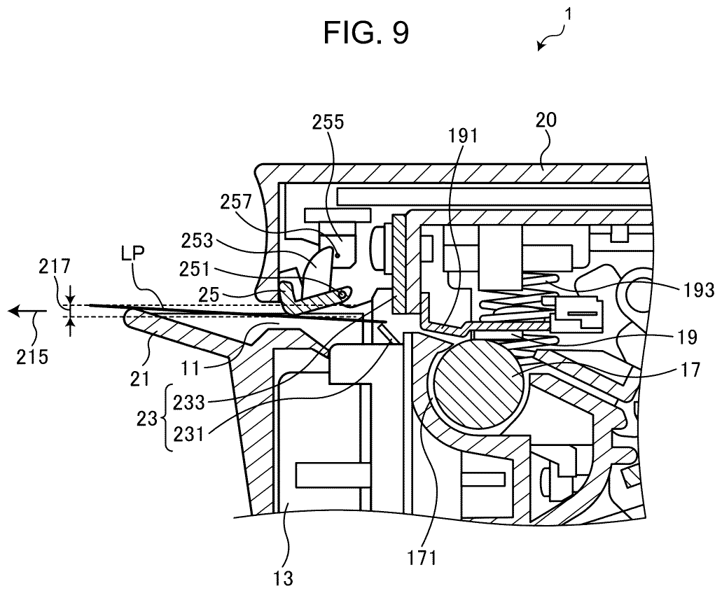

FIG. 9 is an enlarged view of a part of the cross-sectional view shown in FIG. 7. As shown in FIG. 9, the print head 19 is disposed to face the platen roller 17. The print head 19 is biased from the front side toward the back side of the sheet LP by the elastic force of a spring 193 via a head member 191 that supports the print head 19. When the cover 13 is opened and the sheet roll LR is replaced, the leading end of the sheet roll LR drawn out by the user is sandwiched between the platen roller 17 and the print head 19, and the cover 13 is closed. As a result, the leading end of the sheet roll LR is held between the platen roller 17 and the print head 19. The platen roller 17 corresponds to a conveyance mechanism that conveys the sheet LP in a conveyance direction 215.

The cutter 23 illustrated in FIG. 9 cuts the sheet LP conveyed by the conveyance mechanism. Specifically, the cutter 23 includes a movable blade 231 and a fixed blade 233. The movable blade 231 is movable in the thickness direction of the sheet LP and is mounted on the cover 13. The movable blade 231 is moved up and down by the moving mechanism under the control of the control unit 100 included in the printer 1. The fixed blade 233 is fixed to the body 20 of the printer 1. When printing on the sheet LP is completed, the movable blade 231 moves from the back side toward the front side of the sheet LP, and the sheet LP is cut by being sandwiched between the moved movable blade 231 and the fixed blade 233.

A biasing member 25 illustrated in FIG. 9 is disposed between the cutter 23 and the support member 21 in the conveyance direction 215 of the sheet LP. The biasing member 25 is biased by a spring (not shown) from the front side toward the back side of the sheet LP. Also, the biasing member 25 is disposed in the body 20 so as to be rotatable about a rotation shaft 251. With this configuration, the biasing member 25 biases the sheet LP from the front side with a biasing force in a biasing direction. When a force (hereinafter referred to as a push-up force) greater than the biasing force is applied from the back side toward the front side of the sheet LP, the biasing member 25 rotates (or is displaced) around the rotation shaft 251. That is, the biasing member 25 is rotated (or displaced) around the rotation shaft 251 by the push-up force from the back side of the sheet LP in a direction opposite to the biasing direction. The biasing member 25 may be referred to as a flapper.

As illustrated in FIG. 9, the support member 21 and the biasing member 25 partially overlap each other by an overlapping length 217 when viewed from the conveyance direction 215 of the sheet LP. The overlapping length 217 is set in advance according to one or more of the material (hardness, smoothness) of the sheet LP, the thickness of the sheet LP, the weight of the sheet LP, and the like. As shown in FIG. 9, the upper end of the support member 21 is located higher than the lower end of the biasing member 25. That is, in the positional relationship between the support member 21 and the biasing member 25, the distal end of the protruding part 211 of the support member 21 overlaps the biasing member 25 when viewed from the conveyance direction 215 of the sheet LP. In addition, as shown in FIG. 9, the protruding part 211 of the support member 21 is inclined at an acute angle with respect to the conveyance direction 215 and extends from the sheet discharge port 11. With this configuration, as shown in FIG. 9, the sheet LP cut by the cutter 23 is held between the support member 21 and the biasing member 25. Specifically, the sheet LP is held by the friction between the upper end of the support member 21 and the sheet LP and the friction between the lower end of the biasing member 25 and the sheet LP.

In the descriptions below, for explanation purposes, it is assumed that the biasing member 25 has a mechanism related to an anti-jam function for preventing a jam of a printed sheet. For example, when a severe jam (or sheet jam) occurs and the sheet LP enters a gap 171 around the platen roller 17, many steps, such as disassembling components related to the platen roller 17, are necessary to clear the sheet jam. To prevent such a problem, the printer 1 of the present embodiment includes an anti-jam mechanism. The anti-jam mechanism includes, for example, a shutter 253 disposed on the biasing member 25, which is disposed downstream of the platen roller 17 and the cutter 23, and a sensor 255 disposed on the cover 13.

In a case where the anti-jam mechanism is not provided in the printer 1, the biasing member 25 is not necessarily biased by a spring. For example, the biasing member 25 may be fixed to the body 20 such that the biasing force is maintained.

The sensor 255 detects the operation (or displacement) of the biasing member 25. The sensor 255 is implemented by, for example, a photodetector and is an example of a detector. Hereinafter, for explanation purposes, it is assumed that the sensor 255 is a photodetector. The photodetector 255 includes a light emitting unit that emits light and a light receiving unit that receives the light. A space (hereinafter referred to as an optical path space) that can accommodate the shutter 253 is provided between the light emitting unit and the light receiving unit. The photodetector 255 is implemented by, for example, a U-shaped photo interrupter.

When the shutter 253 moves along with the rotation (or displacement) of the biasing member 25 and enters the optical path space formed by the U shape, the shutter 253 blocks the light passing through an optical path 257 connecting the light emitting unit to the light receiving portion. When the light is blocked and does not arrive at the light receiving unit, the photodetector 255 detects a change in the light intensity, and outputs a current (hereinafter referred to as a detection current) corresponding to the detection to the control unit 100 of the printer 1.

When receiving the detection current, the control unit 100 stops the rotation of the platen roller 17 and stops printing on the sheet LP. That is, the control unit 100 stops conveyance of the sheet LP when displacement of the biasing member 25 is detected by the sensor 255. In addition, the control unit 100 stops printing on the sheet LP.

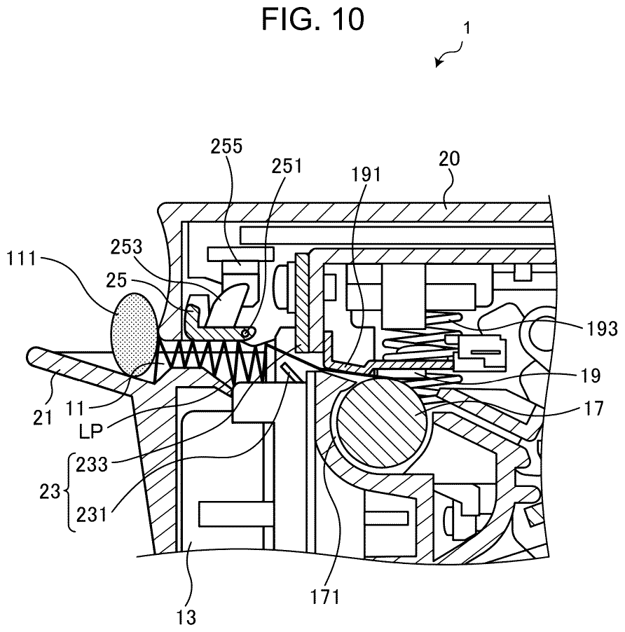

FIG. 10 is a diagram illustrating a state where the biasing member 25 is rotated (or displaced) around the rotation shaft 251 in a direction opposite to the biasing direction due to the occurrence of a jam. As illustrated in FIG. 10, for example, a jam may occur when an obstruction 111 that inhibits the discharge of the sheet LP is present at the sheet discharge port 11. The obstruction 111 is, for example, a finger of the user, an object heavier than the sheet LP, or the like. As shown in FIG. 10, a jam may occur when the sheet LP, on which information has been printed, is conveyed and bent by the obstruction 111. When an upward force generated by the bent sheet LP exceeds the biasing force, the biasing member 25 rotates (or is displaced) around the rotation shaft 251 in a direction opposite to the biasing direction. As a result, the shutter 253 disposed on the biasing member 25 blocks the light, and conveyance of the sheet LP and printing on the sheet LP are stopped.

Note that the anti-jam mechanism is not necessarily implemented by a combination of the shutter 253 on the biasing member 25 and the photodetector 255 that detects the shutter 253. For example, the anti-jam mechanism may include an actuator connected to the biasing member 25 and a detector that includes a switch and detects a movement (or displacement) of the actuator. In this case, the actuator presses the switch of the detector, which corresponds to the sensor 255, according to the movement (or displacement) of the biasing member 25. When the switch of the detector is pressed, the control unit 100 stops the rotation of the platen roller 17 and printing on the sheet LP.

The anti-jam mechanism is not only used to stop the conveyance of the sheet LP and printing on the sheet LP when a jam is detected. For example, the anti-jam mechanism also functions when the sheet LP is pulled by, for example, the user in the direction that the front side of the sheet LP faces before the sheet LP is cut by the cutter 23 (hereinafter, this state is referred to as a sheet pulled state).

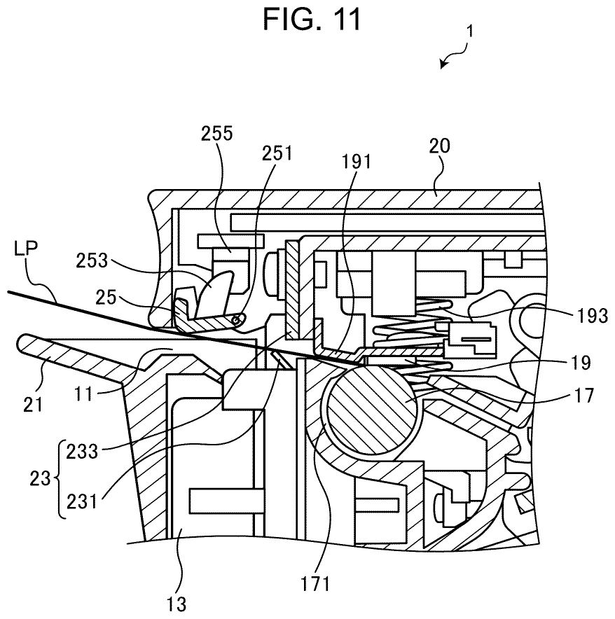

FIG. 11 is a diagram illustrating an example of a sheet pulled state. As shown in FIG. 11, when the sheet LP is pulled in the direction that the front side of the sheet LP faces, the sheet LP pushes the biasing member 25 upward, i.e., in a direction opposite to the biasing direction. As a result, the biasing member 25 rotates around the rotation shaft 251. When the shutter 253 moves along with the rotation of the biasing member 25 and enters the optical path space formed by the U shape, the shutter 253 blocks the light passing through the optical path 257 connecting the light emitting unit to the light receiving unit. As a result, the photodetector 255 outputs a detection current to the control unit 100. When receiving the detection current, the control unit 100 stops the rotation of the platen roller 17 and printing on the sheet LP.

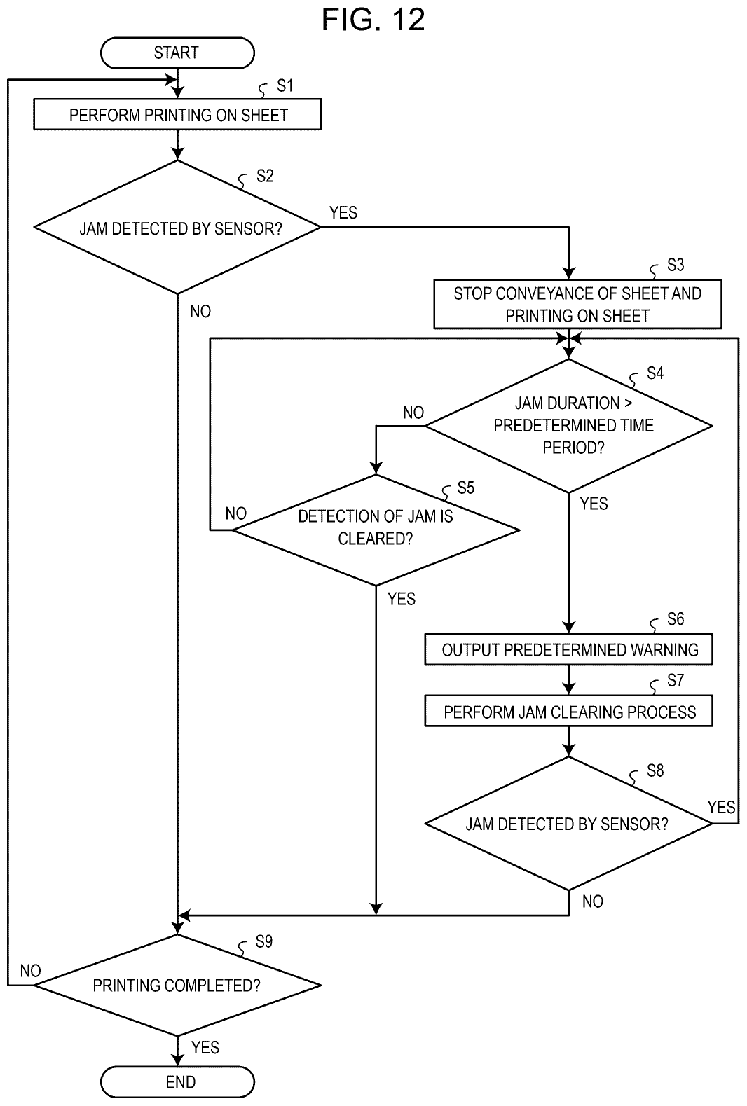

Next, an example of a process performed by the printer 1 will be described with reference to FIG. 12. FIG. 12 is a flowchart illustrating an example of a process performed by the printer 1. Here, it is assumed that the control unit 100 performs steps in the process described below. In other words, the processor of the printer 1 is configured to perform steps in the process described below.

First, the control unit 100 drives the print head 19. Next, the control unit 100 performs printing on the sheet LP at a printing starting position (step S1). Subsequently, the control unit 100 drives the first drive motor 106 for the platen roller 17. As a result, the sheet LP is conveyed toward the sheet discharge port 11.

The control unit 100 determines whether a jam has been detected by the sensor (or photodetector) 255 (step S2). The detection of a jam corresponds to the detection of displacement of the biasing member 25 by the sensor 255. Specifically, as shown in FIG. 10, the detection of a jam corresponds to the detection of an event in which the biasing member 25 rotates (or is displaced) around the rotation shaft 251 in a direction opposite to the biasing direction when the push-up force of pushing the sheet LP upward exceeds the biasing force and as a result, the shutter 253 enters the optical path space. That is, whether a jam has been detected corresponds to whether the control unit 100 has received a detection current output from the photodetector 255.

When a jam has been detected by the sensor (or photodetector) 255 (step S2: Yes), step S3 is performed. When a jam is detected, the control unit 100 starts counting time from when the jam is detected, that is, from the reception time of the detection current. The counted time is stored, for example, in the RAM 103. The counted time corresponds to the time (hereinafter referred to as a jam duration) during which the jam continues to be detected.

When no jam has been detected by the sensor (photodetector) 255 (step S2: No), step S9 is performed.

When a jam has been detected (step S2: Yes), the control unit 100 stops driving the first drive motor 106 and the print head 19. Thus, the control unit 100 stops conveyance of the sheet LP and printing on the sheet LP (step S3). That is, the control unit 100 stops conveyance of the sheet LP when displacement of the biasing member 25 is detected by the sensor 255. In other words, the processor of the printer 1 is configured to control the conveyance mechanism to stop conveying the sheet LP and control the print head 19 to stop printing on the sheet LP when displacement of the biasing member 25 is detected by the sensor 255.

The control unit 100 compares the jam duration with a predetermined time period. The predetermined time period is preset and stored in the ROM 102 or the RAM 103. The predetermined time period indicates a duration within which a detected jam is naturally cleared without developing into a severe jam, that is, when the jam is temporary. The control unit 100 determines whether the jam duration has exceeded the predetermined time period read from the ROM 102 or the RAM 103 (step S4). The predetermined time period can be appropriately set via an operation unit (not shown).

When the jam duration has not exceeded the predetermined time period (step S4: No), step S5 is performed to determine whether the detection of the jam has been cleared. When the jam duration has exceeded the predetermined time period (step S4: Yes), step S6 is performed.

When the detection of the jam has not been cleared (step S5: No), step S4 is performed again. When the detection of the jam has been cleared (step S5: Yes), step S9 is performed. When the biasing member 25 returns to an initial position, to which the biasing member 25 is biased by the spring, and the detection of the jam by the sensor 255 is cleared within the predetermined time period after the displacement of the biasing member 25 is detected and when the printing has not been completed (step S9: No), the control unit 100 controls the conveyance mechanism to resume conveying the sheet LP and controls the print head 19 to resume printing on the sheet LP.

When the jam duration has exceeded the predetermined time (step S4: Yes), the control unit 100 outputs a predetermined warning (step S6). For example, the control unit 100 causes a speaker (not shown) to output a sound indicating the occurrence of a jam and a request to clear the jam. Note that the predetermined warning is not necessarily output by a sound. For example, information indicating the occurrence of a jam and a request to clear the jam may be displayed on a monitor (not shown).

Then, a jam clearing process is performed (step S7). In the jam clearing process, for example, the user opens the cover 13 and removes the jammed sheet. Next, the user places the leading end of the sheet LP drawn out from the sheet roll LR between the platen roller 17 and the print head 19. Then, the user closes the cover 13.

When the closing of the cover 13 is detected by a sensor (not shown), the control unit 100 determines again whether a jam has been detected by the sensor (or photodetector) 255 (step S8). That is, when the detection of the jam by the sensor 255 is not cleared within the predetermined time period and the cover 13 is opened and closed to clear the jam of the sheet LP, the control unit 100 determines again whether displacement of the biasing member 25 (or a jam) is detected by the sensor 255.

When a jam is detected by the sensor (or photodetector) 255 (step S8: Yes), step S4 is performed. When no jam is detected by the sensor (or photodetector) 255 (step S8: No), step S9 is performed.

When the printing on the sheet LP has been completed (step S9: Yes), the process performed by the printer 1 is terminated. Then, the control unit 100 moves the movable blade 231 of the cutter 23 upward to cut the sheet LP. When the printing on the sheet LP has not been completed (step S9: No), step S1 and subsequent steps are repeated.

As described above, the printer 1 according to the present embodiment includes the cutter 23 that cuts the sheet LP conveyed by the conveyance mechanism, the support member 21 that is disposed at the sheet discharge port 11 from which the sheet LP cut by the cutter 23 is discharged and supports the sheet LP discharged from the sheet discharge port 11 from the back side of the sheet LP, and the biasing member 25 that is disposed between the cutter 23 and the support member 21 in the conveyance direction 215 of the sheet LP and biases the sheet LP from the front side of the sheet LP. The support member 21 and the biasing member 25 partially overlap each other when viewed from the conveyance direction 215 of the sheet LP, and the sheet LP cut by the cutter 23 is held between the support member 21 and the biasing member 25.

Thus, according to the printer 1 of the present embodiment, when the sheet LP is horizontally discharged, the sheet LP fully cut off by the cutter 23 can be held by the friction between the upper end of the support member 21 and the sheet LP and the friction between the lower end of the biasing member 25 and the sheet LP. That is, the present embodiment makes it possible to provide the printer 1 that can prevent the sheet LP, which has been cut and discharged from the sheet discharge port 11, from falling off.

Also, the printer 1 according to the present embodiment includes the sensor 255 for detecting the displacement of the biasing member 25 and stops the conveyance of the sheet LP when the displacement of the biasing member 25 is detected by the sensor 255. With this configuration, the printer 1 of the present embodiment can prevent a severe jam (or sheet jam) in which the sheet LP enters the gap 171 around the platen roller 17. The sensor 255 can also detect a sheet pulled state. The printer 1 according to the present embodiment stops conveyance of the sheet LP and printing on the sheet LP when the sheet pulled state is detected by the sensor 255. With this configuration, the printer 1 of the present embodiment can reduce, for example, errors in printing even when the sheet LP is pulled by the user or the like in a direction in which the front side of the sheet LP faces. Also, the printer 1 of the present embodiment can prevent a cut sheet LP from returning to the upstream side. This in turn makes it possible to prevent the sheet LP from being cut multiple times and prevent the occurrence of a severe jam of the sheet LP.

Also, when the biasing member 25 returns to the initial position, to which the biasing member 25 is biased by the spring, and the detection of the displacement of the biasing member 25 by the sensor 255 is cleared within the predetermined time period after the displacement of the biasing member 25 is detected, the printer 1 resumes the conveyance of the sheet LP. Thus, according to the printer 1 of the present embodiment, when a jam is naturally cleared within a predetermined time period, it is possible to promptly resume printing without performing a jam clearing process including a step of opening the cover 13.

Also, the printer 1 according to the present embodiment determines again whether displacement of the biasing member 25 is detected by the sensor 255 when the detection by the sensor 255 is not cleared within a predetermined time period after the displacement of the biasing member 25 is detected by the sensor 255 and the cover 13, to which the support member 21 is attached, is opened and closed to clear the jam of the sheet LP. Thus, according to the printer 1 of the present embodiment, even when the user has not sufficiently removed a jammed sheet LP, it is possible to prevent a severe jam (or sheet jam) in which the sheet LP enters the gap 171 around the platen roller 17.

Furthermore, in the printer 1 according to the present embodiment, the support member 21 is detachably attached to the sheet discharge port 11 or is formed as an integral part of the sheet discharge port 11. With the configuration of the printer 1 according to the present embodiment, it is possible to reduce the size of the printer 1 by removing the support member 21 or replacing the cover 13 in accordance with the orientation of the sheet discharge port 11 of the printer 1 and/or the sheet cutting mode. For example, when the sheet discharge port 11 faces the horizontal direction and the sheet LP is fully cut, the support member 21 is provided at the sheet discharge port 11. Also, when the sheet discharge port 11 faces the horizontal direction and the sheet LP is partially cut, the support member 21 can be removed. Furthermore, when the sheet discharge port 11 faces upward in the vertical direction, the support member 21 can be removed regardless of the sheet cutting mode.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A printer comprising:
a roller that conveys a sheet in a conveyance direction;
a print head configured to perform printing on the sheet;
a cutter that cuts the sheet that is conveyed by the roller and on which the printing is performed by the print head;
a support member that is disposed at a sheet discharge port from which the sheet cut by the cutter is discharged and supports the sheet discharged from the sheet discharge port from a back side of the sheet; and
a biasing member that is disposed between the cutter and the support member in the conveyance direction and biases the sheet from a front side of the sheet, wherein
the support member and the biasing member partially overlap each other when viewed from the conveyance direction so that the sheet cut by the cutter is held between the support member and the biasing member.

2. The printer according to claim 1, further comprising:
a sensor configured to detect displacement of the biasing member; and
a processor configured to control the roller to stop conveying the sheet when the displacement of the biasing member is detected by the sensor.

3. The printer according to claim 2, wherein the processor is configured to also control the print head to stop the printing on the sheet when the displacement of the biasing member is detected by the sensor.

4. The printer according to claim 2, wherein the processor is configured to control the roller to resume conveying the sheet when the biasing member returns to an initial position and detection of the displacement of the biasing member by the sensor is cleared within a predetermined time period after the displacement of the biasing member is detected.

5. The printer according to claim 4, wherein the processor is configured to
count time from when the displacement of the biasing member is detected,
determine whether the counted time has exceeded the predetermined time period, and
when the counted time has not exceeded the predetermined time period, determine whether the detection of the displacement of the biasing member by the sensor has been cleared.

6. The printer according to claim 5, wherein when the detection of the displacement of the biasing member by the sensor has been cleared, the processor determines whether the printing has been completed.

7. The printer according to claim 6, wherein the processor is configured to control the roller to resume conveying the sheet when the printing has not been completed.

8. The printer according to claim 5, wherein the processor is configured to output a warning when the counted time has exceeded the predetermined time period.

9. The printer according to claim 4, further comprising:
a cover that opens and closes the printer, wherein
when the detection of the displacement of the biasing member by the sensor is not cleared within the predetermined time period and the cover is opened and closed, the processor determines again whether the displacement of the biasing member is detected by the sensor.

10. The printer according to claim 2, wherein
the biasing member is rotatable around a rotation shaft and is biased by a spring to bias the sheet with a biasing force in a biasing direction; and
when a force greater than the biasing force is applied from the back side toward the front side of the sheet, the biasing member rotates in a direction opposite to the biasing direction, the force being generated when a jam occurs or the sheet is pulled in a direction that the front side of the sheet faces.

11. The printer according to claim 10, further comprising:
a shutter disposed on the biasing member, wherein
the sensor is a photodetector that detects the shutter when the biasing member is rotated by the force in the direction opposite to the biasing direction.

12. The printer according to claim 10, further comprising:
an actuator connected to the biasing member, wherein
the sensor includes a switch, and
the actuator presses the switch of the sensor when the biasing member is rotated by the force in the direction opposite to the biasing direction.

13. The printer according to claim 1, wherein
the support member includes a protrusion extending from the sheet discharge port,
a distal end of the protrusion overlaps the biasing member when viewed from the conveyance direction, and
the protrusion is inclined with respect to the conveyance direction.

14. The printer according to claim 13, further comprising:
a body capable of housing a roll of the sheet; and
a cover that opens and closes an opening of the body and to which the support member is attached, wherein
a length of the protrusion and an inclination of the protrusion with respect to the conveyance direction are set such that the roll of the sheet is insertable through the opening into the body when the cover is opened until the protrusion contacts a horizontal surface on which the printer is installed.

15. The printer according to claim 1, wherein the support member is detachably attached to the sheet discharge port.

16. The printer according to claim 1, wherein the support member is formed as an integral part of the sheet discharge port.

17. The printer according to claim 1, wherein a length by which the support member and the biasing member partially overlap each other is set according to one or more of a material, a thickness, and a weight of the sheet.

18. The printer according to claim 1, wherein an upper end of the support member is located higher than a lower end of the biasing member.

19. A method performed by a printer that includes:
a roller that conveys a sheet in a conveyance direction,
a print head configured to perform printing on the sheet,
a cutter that cuts the sheet that is conveyed by the roller and on which the printing is performed by the print head,
a support member that is disposed at a sheet discharge port from which the sheet cut by the cutter is discharged and supports the sheet discharged from the sheet discharge port from a back side of the sheet, and
a biasing member that is disposed between the cutter and the support member in the conveyance direction and biases the sheet from a front side of the sheet, the support member and the biasing member partially overlapping each other when viewed from the conveyance direction so that the sheet cut by the cutter is held between the support member and the biasing member,
the method comprising:
determining whether displacement of the biasing member is detected; and
controlling the roller to stop conveying the sheet when the displacement of the biasing member is detected.

20. A non-transitory computer-readable storage medium storing a program for causing a processor of a printer to perform a process, the printer including:
a roller that conveys a sheet in a conveyance direction,
a print head that performs printing on the sheet,
a cutter that cuts the sheet that is conveyed by the roller and on which the printing is performed by the print head,
a support member that is disposed at a sheet discharge port from which the sheet cut by the cutter is discharged and supports the sheet discharged from the sheet discharge port from a back side of the sheet, and
a biasing member that is disposed between the cutter and the support member in the conveyance direction and biases the sheet from a front side of the sheet, the support member and the biasing member partially overlapping each other when viewed from the conveyance direction so that the sheet cut by the cutter is held between the support member and the biasing member,
the process including:
determining whether displacement of the biasing member is detected; and
controlling the roller to stop conveying the sheet when the displacement of the biasing member is detected.
